(19) United States
(12) Patent Application Publication
(10) Pub. No.: US 2025/0252416 A1
(43) Pub. Date: Aug. 7, 2025

(54) SYSTEMS AND METHODS FOR CASHLESS VENDING

(71) Applicant: USConnect, LLC, Greensboro, NC (US)

(72) Inventors: Jeff Whitacre, Greensboro, NC (US); Konrad Alvarino, Greensboro, NC (US)

(73) Assignee: USConnect, LLC, Greensboro, NC (US)

(21) Appl. No.: 19/039,917

(22) Filed: Jan. 29, 2025

Related U.S. Application Data
(60) Provisional application No. 63/549,127, filed on Feb. 2, 2024.

(51) Int. Cl. G06Q 20/18; G06Q 20/32

(52) U.S. Cl. CPC G06Q 20/18; G06Q 20/3276

(57) ABSTRACT

A vending machine system and method for cashless vending of goods of a vending machine. One or more servers, which may include a remote server, communicate with one or more vending machines and communicate with one or more remote devices, which may include a user device. A code sent from a remote device, in wireless communication, is received at the one or more servers and is indicative of a specific vending machine. The code may be a quick-response (QR) code displayed by the specific vending machine, and may be scanned by the remote device. An available balance is transmitted from the one or more servers to the specific vending machine. A transaction amount from the specific vending machine, based on a selected good, is received at the one or more servers. The transaction amount is deducted from the available balance. The specific vending machine may then vend the selected good.

### CROSS-REFERENCE TO RELATED APPLICATION

This application claims benefit of priority from U.S. Provisional Application Ser. No. 63/549,127, filed Feb. 2, 2024, which is hereby incorporated by reference.

### BACKGROUND

### 1. Technical Field

The present disclosure relates to systems and processes that provide for and facilitate cashless self-service purchase of goods and, more specifically, cashless purchase of goods from vending machine systems.

### 2. Discussion of Related Art

Vending machines have been utilized to provide various snacks, beverages, and other goods to customers. Vending machines dispense selected products to customers in response to payment. Payment may be in the form of money, which may be paper and/or coins, or swiping or tapping, or chip insert of credit or debit cards. Payment may also be tendered through loyalty cards having a pre-loaded account balance.

One known form of cashless vending at a vending machine includes a credit card reader at the vending machine, accepting a consumer credit card (e.g., swipe, insert, or tap by a user). The credit card reader communicates, for example wirelessly over a network, to a payment gateway. A data processing center receives encrypted data, communicates with a credit card processor for approval, and communication back to the credit card reader through the payment gateway signals to accept or deny the transaction.

When a customer has selected a product, the customer provides a method of payment then the vending machine actuates a selection switch panel to select a desired product within the vending machine. When this has occurred, a dispensing device for the desired product is operated and the desired product moves from a dispensing location to a product retrieval location. The customer manually retrieves the desired product at the product retrieval location.

### SUMMARY

This disclosure relates generally to systems and methods for cashless purchase of goods from a vending machine utilizing a remote device such as a cell phone. Vending machines and remote devices may communicate with one another through one or more servers, such as a remote server, telemeter server, loyalty server, etc., and may use a cashless payment device.

In an aspect of the present disclosure, a method for cashless vending of goods of a vending machine is performed by one or more servers. The method includes receiving, at the one or more servers, a code sent from a remote device in wireless communication with the one or more servers. The code is indicative of a specific vending machine. The method includes transmitting, from the one or more servers, an available balance to the specific vending machine. The method includes receiving, at the one or more servers, a transaction amount from the specific vending machine based on a selected good. The method includes deducting the transaction amount from the available balance.

In aspects, the method may include adding a promotion for a specific good to be vended at no charge or reduced price. The promotion may be added to the specific vending machine in response to receiving the code from the remote device.

In some aspects, the code that indicates the specific vending machine may be a quick-response (QR) code displayed by the specific vending machine.

In certain aspects, the code that indicates the specific machine may be a quick-response (QR) code that is read by the remote device.

In particular aspects, the method may include generating, by the one or more servers, a quick-response (QR) code. The method may include communicating the QR code from the one or more servers to the specific vending machine. The QR code may be displayed by the specific vending machine as the code that indicates the specific vending machine.

In aspects, the method may include receiving, by the one or more servers, a purchase and vending selection indicating the selected good, from the specific vending machine.

In some aspects, the method may include receiving, by the one or more servers, a purchase and vending selection indicating the selected good, from the remote device.

In another aspect of the present disclosure, a vending machine system for cashless vending of goods includes one or more servers. The servers are configured for communication with one or more vending machines and communication with one or more remote devices. The one or more servers are to perform a method. The method includes receiving, at the one or more servers, a code sent from a remote device in wireless communication with the one or more servers. The code is indicative of a specific vending machine. The method includes transmitting, from the one or more servers, an available balance to the specific vending machine. The method includes receiving, at the one or more servers, a transaction amount from the specific vending machine based on a selected good. The method includes deducting the transaction amount from the available balance.

In aspects, the method to be performed by the one or more servers may include adding a promotion for a specific good to be vended at no charge or reduced price. The promotion may be added to the specific vending machine in response to receiving the code from the remote device.

In some aspects, the vending machine system for cashless vending of goods may include one or more vending machines, each arranged to display a quick-response (QR) code to indicate the specific vending machine.

In certain aspects, the method to be performed by the one or more servers may include generating, by the one or more servers, a quick-response (QR) code. The method may include communicating the QR code from the one or more servers to the specific vending machine, to be displayed by the specific vending machine as the code that indicates the specific vending machine.

In particular aspects, the method to be performed by the one or more servers may include receiving, by the one or more servers, a purchase and vending selection indicating the selected good, from the specific vending machine.

In aspects, the method to be performed by the one or more servers may include receiving, by the one or more servers, a purchase and vending selection indicating the selected good, from the remote device.

In another aspect of the present disclosure, a server-based vending machine system for cashless vending of goods includes two servers, including a remote server. The two servers are to communicate with vending machines and remote devices. Such remote devices are to communicate with such vending machines through the two servers. The two servers are to perform a method. The method includes receiving, at the remote server, a code sent from a remote device in wireless communication with the remote server. The code is indicative of a specific vending machine. The method includes transmitting, from the remote server, an available balance to the specific vending machine. The method includes receiving a transaction amount from the specific vending machine based on a selected good. The method includes deducting the transaction amount from the available balance.

In aspects, the server-based vending machine system for cashless vending of goods may have the method performed by the two servers include adding a promotion for a specific good to be vended at no charge or reduced price, to the specific vending machine in response to receiving the code from the remote device.

In some aspects, the code that indicates the specific vending machine may be a quick-response (QR) code displayed by the specific vending machine.

In certain aspects, the code that indicates the specific vending machine may be a quick-response (QR) code that is read by the remote device.

In particular aspects, the server-based vending machine system for cashless vending of goods may have the method performed by the two servers include generating a quick-response (QR) code. The method may include communicating the QR code to the specific vending machine, to be displayed by the specific vending machine as the code that indicates the specific vending machine.

In aspects, the method performed by the two servers of the server-based vending machine system for cashless vending of goods may include receiving a purchase and vending selection indicating the selected good, from the specific vending machine.

In some aspects, the method performed by the two servers of the server-based vending machine system for cashless vending of goods may include receiving a purchase and vending selection indicating the selected good, from the remote device.

In another aspect of the present disclosure, a method of operating a vending machine includes receiving an input signal by a cashless payment device of a vending machine from a remote device requesting initiation of a vending transaction, establishing wireless communication between the cashless payment device and the remote device, selecting a good for vending from the vending machine, transferring a purchase price of the selected good across the wireless communication established between the cashless payment device and the remote device, issuing a command signal to vend the selected good, and presenting confirmation of payment. Establishing the wireless communication between the cashless payment device and the remote device includes reading a QR code displayed on a display screen of the cashless payment device with the remote device.

In another aspect of the present disclosure, a vending machine system includes a vending machine and a remote device. The vending machine is configured to dispense a plurality of goods therefrom. The vending machine includes a cashless payment device having a display screen. The cashless payment device is capable of displaying a QR code on the display screen. The remote device is capable of reading the QR code to initiate wireless communication with the cashless payment device such that a cashless vending transaction in which payment for a selected good of the plurality of goods is transferred across the wireless communication and the selected good is dispensed from the vending machine.

In another aspect of the present disclosure, a vending machine system as shown and described herein.

In another aspect of the present disclosure, a method of operating a vending machine system as shown and described herein.

In another aspect of the present disclosure, a controller to operate a vending machine system as shown and described herein.

In another aspect of the present disclosure, a non-transitory computer-readable storage medium having instructions stored thereon that, when executed by a controller, cause the controller to execute a vending transaction as shown and described herein.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are not necessarily drawn to scale, which are incorporated in and constitute a part of this specification, wherein:

FIG. 1 is a schematic illustration of a vending machine system in accordance with embodiments of the present disclosure;

FIG. 2 is a flow chart illustrating a process flow of a cashless vending transaction utilizing the vending machine system illustrated in FIG. 1;

FIG. 3 is a flow chart illustrating operations of a cashless payment device of the vending machine system of FIG. 1;

FIG. 4 is a flow chart detailing a payment process executed between a telemeter server and a cashless payment device of the vending machine system of FIG. 1;

FIG. 5 is a flow chart illustrating a method of operating a vending machine system in accordance with embodiments of the present disclosure;

FIG. 6 is a front view of an example vending machine in accordance with embodiments of the present disclosure;

FIG. 7 is a perspective view of a portion of the vending machine of FIG. 6;

FIG. 8 is a perspective view of an example vending machine system in accordance with embodiments of the present disclosure including the vending machine of FIG. 6 and a remote device;

FIGS. 9-13 illustrate aspects of the example vending machine system of FIGS. 1 and 2 through the processes of operation described in the method of FIG. 5; and

FIG. 14 is a block diagram of an example controller of a cashless payment device of the vending machine system of FIG. 1 that may perform one or more of the processes described herein.

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like.

As used herein, the term “cashless” refers to transactions performed without the use of cash, e.g., paper bills or coins. The term “vendor application” refers to software installed on a remote device for performing cashless transactions with a vending machine. The term “loyalty account” refers to a user specific account of the vendor application. The term “vending machine” may refer to attended or unattended payment points, e.g., self-checkout registers or micro-market checkouts.

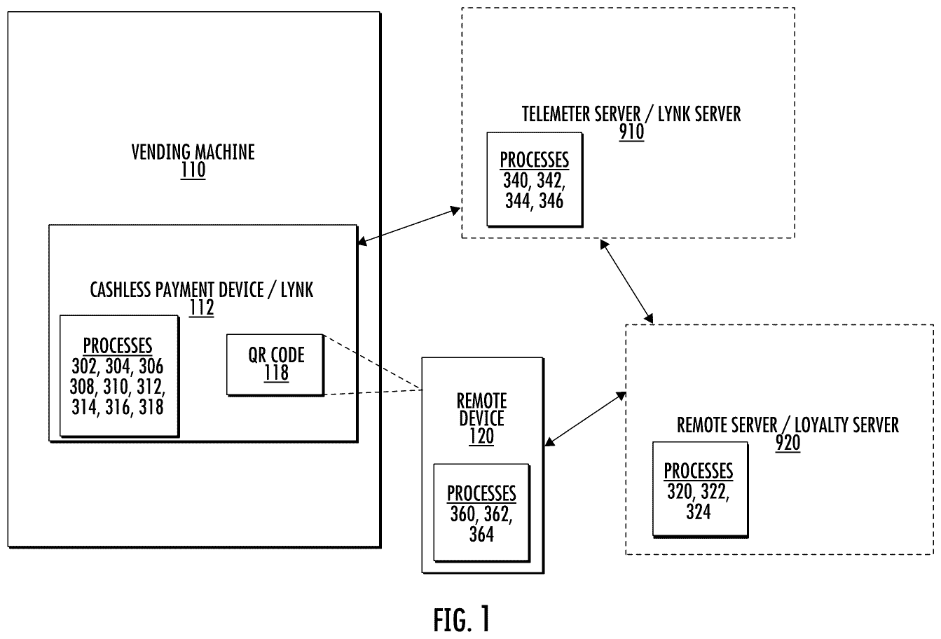

Referring to FIG. 1, a vending machine system 100 in accordance with embodiments of the present disclosure is schematically shown. The vending machine system 100 includes a vending machine 110 for containing and vending of a plurality of goods, e.g., food and beverage items, and a remote device 120. The vending machine 110 and the remote device 120 communicate with one another via one or more servers to facilitate cashless payment and vending of goods from the vending machine 110. That is, the vending machine 110 and the remote device 120 are communicating indirectly with one another, through one or more servers, and the vending machine 110 and the remote device 120 are not in direct wireless or wired communication with one another. The remote device 120 may belong to a user, and would not be considered part of or belonging to the vending machine 110, e.g., in contrast to a credit card reader that may be in direct communication with a vending machine. For example, the vending machine 110 and the remote device 120 communicate through a LYNK® server or a telemeter server 910 and a loyalty server or a remote server 920. Communication between the vending machine 110 and the remote device 120 through one or more servers may allow for increased security in the connection between the vending machine 110 and the remote device 120. However, in some embodiments, the vending machine 110 and the remote device 120 may be in direct wireless communication with one another.

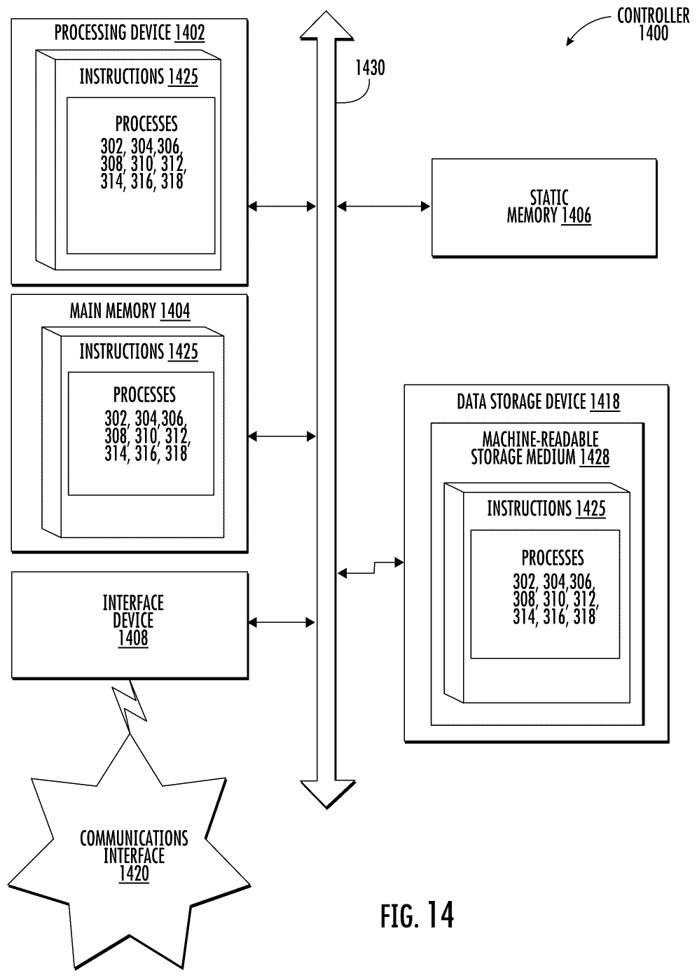

The vending machine 110 or the cashless payment device 112 may include a controller 1400 (FIG. 14) to perform some processes of the vending transaction. The vending machine 110 may be in signal communication with the telemeter server 910 and the remote server 920. The telemeter server 910 and the remote server 920 may be a wide area network (WAN) or a local area network (LAN). The cashless payment device 112 may be in two-way wireless communication with the telemeter server 910 via a wired or wireless connection. For example, the cashless payment device 112 may be in communication over a telecommunications network or other wireless LAN or WAN. In some embodiments, the cashless payment device 112 joins a virtual private network (VPN) with the telemeter server 910 through the wired or wireless connection. The remote device 120 may establish wireless communication with the vending machine 110 via the remote server 920 or the telemeter server 910. Establishing wireless communication through the telemeter server 910 or the remote server 920 may provide improved security to conduct the vending transaction. In some embodiments, the vending machine 110 and the remote device 120 may communicate directly with one another to conduct vending transactions over WiFi, Bluetooth®, Near Field Communications (NFC), or telecommunication networks, e.g., 3G, 4G, or 5G networks.

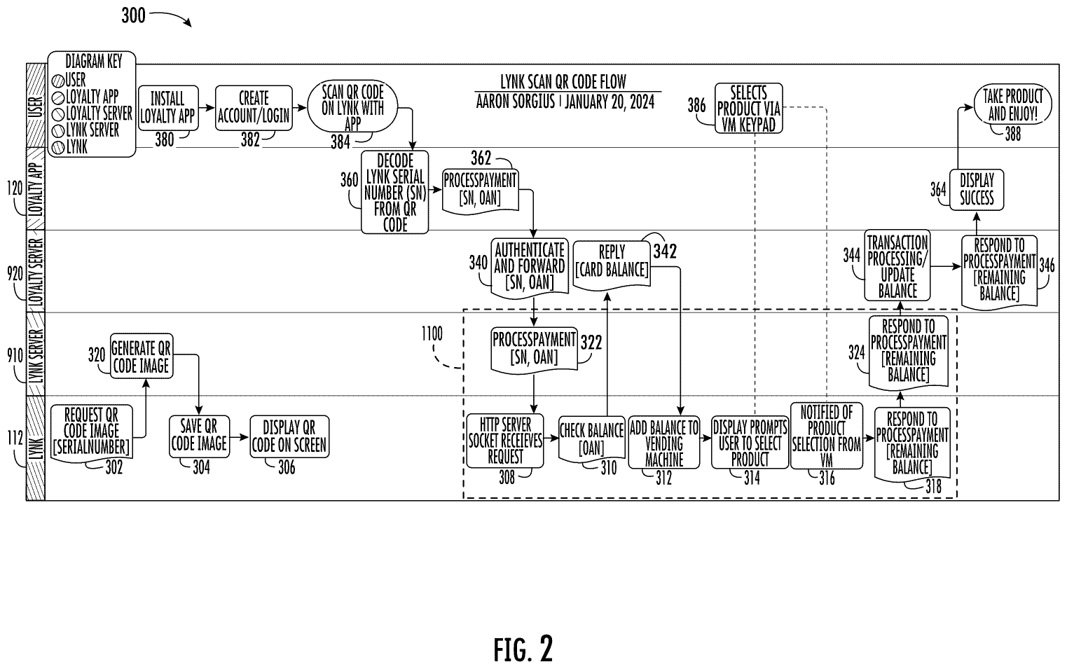

Additionally referring to FIG. 2, a flow chart illustrating a process flow 300 of a cashless vending transaction utilizing the vending machine system 100 is shown in accordance with embodiments of the present disclosure. The process flow 300 shows the communication between the cashless payment device 112, the remote device 120, the telemeter server 910, the remote server 920, and a user.

The cashless payment device 112 sends a request to the telemeter server 910 to generate a QR code 118 (Process 310). The telemeter server 910 generates the QR code 118 and sends the QR code 118 to the cashless payment device 112 to be visually displayed (Process 320). The cashless payment device 112 may receive a request from the telemeter server 910 to process a payment (Process 308). The cashless payment device 112 may send a request to the remote server 920 to check the account balance available in a loyalty account of a user for the cashless vending transaction (Process 310). The cashless payment device 112 may receive a reply from the remote server 920 with the account balance and add the account balance to the cashless payment device 112 for transacting (Process 312). The cashless payment device 112 may display prompts for the user to select a product for vending (Process 314). The cashless payment device 112 may receive the product selection from the remote device 120 (Process 316). In some embodiments, the cashless payment device 112 may directly receive the product selection from a user, e.g., pressing buttons on the cashless payment device 112 or buttons on the vending machine 110. The cashless payment device 112 sends the remaining account balance associated with the loyalty account of the user after the vending transaction to the telemeter server 910 (Process 318).

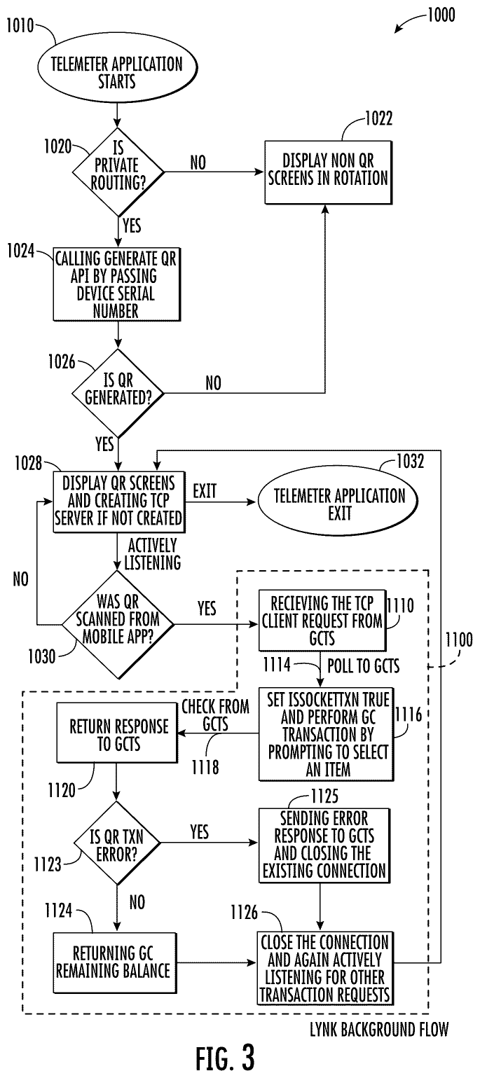

With additional reference to FIG. 3, an operational flowchart 1000 of the cashless payment device 112 is shown in accordance with the present disclosure and details the process performed by the cashless payment device 112. A telemeter application starts (Process 1010) and checks for connection to the telemeter server 910 (Process 1020). The connection to the telemeter server 910 may be hardwired to the vending machine 110 or cashless payment device 112 or may be a wireless connection. If there is no connection to the telemeter server 910, the cashless payment device 112 displays a screen without a QR code 118 (Process 1022) until a connection to the telemeter server 910 is detected (Process 1024). The connection between the cashless payment device 112 and the telemeter server 910 may be a private Access Point Name (APN) connection. The remote device 120 may call for generation of the QR code 118 (Process 1026). The telemeter server 910 generates the QR code 118 (Process 1102). The cashless payment device 112 saves the QR code 118 (Process 1104). If the QR code 118 is generated, the QR code 118 is displayed on the display screen 116 of the cashless payment device 112 (Process 1028). The cashless payment device 112 listens for confirmation that the remote device 120 has scanned the QR code 118 (Process 1030). The cashless payment device 112 may receive confirmation from the telemeter server 910. If the cashless payment device 112 does not receive confirmation the telemeter application may exit (Process 1032). If the cashless payment device 112 receives confirmation of scanning communication between the cashless payment device 112 and the telemeter server 910 is established and payment process 1100 is commenced.

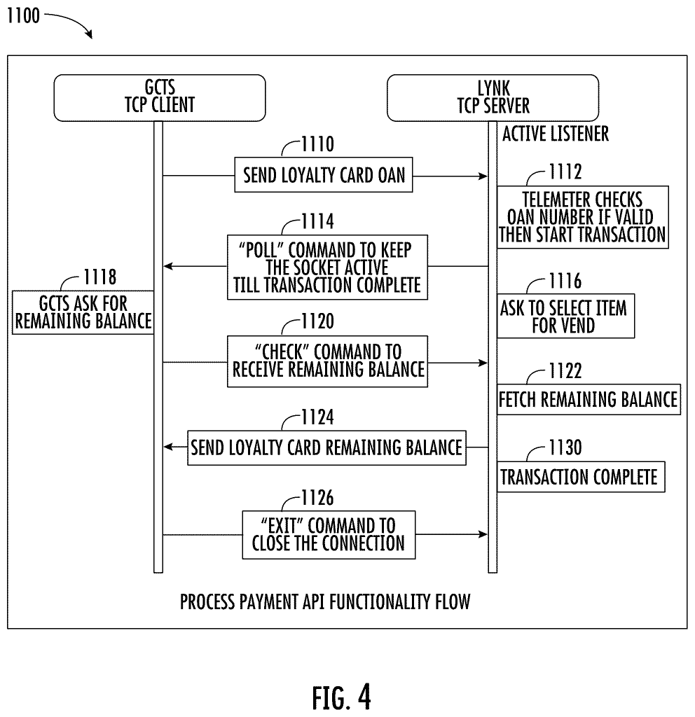

With additional reference to FIG. 4, an operational flow chart illustrating a payment process 1100 is shown in accordance with embodiments of the present disclosure detailing process performed between telemeter server 910 and the cashless payment device 112. The telemeter server 910 receives a communication from the cashless payment device 112 with the payment method, e.g., an account number associated with the loyalty account, (Process 1110). In some embodiments, the payment method may be a credit card number. The cashless payment device 112 validates the payment method and starts the transaction (Process 1112). Once authenticated, the cashless payment device 112 sends a poll command to continue the payment process 1100 (Process 1114). The telemeter server 910 requests the remaining account balance 124 available to transact and sends a check command (Processes 1118 and 1120). The telemeter server 910 or the cashless payment device 112 may confirm validity of the transaction initiated by scanning the QR code 118 (Process 1123). If the transaction is in error, the connection with the telemeter server 910 may be closed and the transaction terminated (Process 1125). If the transaction is not in error, the account balance 124 available after the transaction is returned to the telemeter server 910 (Process 1124). The transaction may be completed and the selected good vended (Process 1130). The connection between the telemeter server 910 may be closed and the cashless payment device 112 may resume listening for transaction requests (Process 1126).

Referring back to FIG. 2, the telemeter server 910 receives an authenticated payment method from the remote server 920 and initiates the payment process with the cashless payment device 112 (Process 322). After the cashless payment device 112 receives the product selection, the telemeter server 910 receives the remaining account balance of the loyalty account of the user after the vending transaction from the cashless payment device 112 and forwards the remaining account balance of the loyalty account to the remote server 920 (Process 324). The cashless payment device 112 may receive the product selection from the cashless payment device 112 or from the remote device 120.

The remote server 920 receives a signal from the remote device 120 to initiate a vending transaction and authenticates the payment method associated with the loyalty account for the vending transaction (Process 340). Once wireless communication between the remote device 120 and the cashless payment device 112 is established, the remote server 920 may receive a request from the cashless payment device 112 to provide the account balance of the loyalty account available (Process 342). The remote server 920 provides the balance available for the cashless vending transaction and provide the account balance. After the cashless payment device 112 receives the product selection from the vending machine 110 or the remote device 120, the telemeter server 910 sends the remaining account balance 124 of the loyalty account to the remote server 920 (Process 344). The remote server 920 updates the remaining account balance 124 of the loyalty account. The remote server 920 finalizes the payment for the vending transaction and sends a signal to the remote device 120 to display a confirmation of a successful transaction (Process 346).

Continuing to refer to FIG. 2, the remote device 120 includes a vendor application installed thereon that has a QR code reading feature. The remote device 120 is used to read the QR code 118 displayed on the cashless payment device 112 (Process 360). After scanning the QR code 118, the remote device 120 communicates with the remote server 920 to initiate the vending transaction (Process 362). The remote device 120 receives a signal from the remote server 920 that the vending transaction is complete and displays a confirmation of a successful transaction (Process 346).

The user installs the vendor application on the remote device 120 (Process 380). Once the vendor application is installed, the user can create a loyalty account or login to an existing loyalty account (Process 382). From within the vendor application, the user may use the remote device 120 to scan the QR code 118 displayed on the cashless payment device 112 (Process 384). A product for vending may be selected by the user on the vending machine 110 or the remote device 120 (Process 386). After selection of the product, the product is dispensed and retrieved by the user (Process 388).

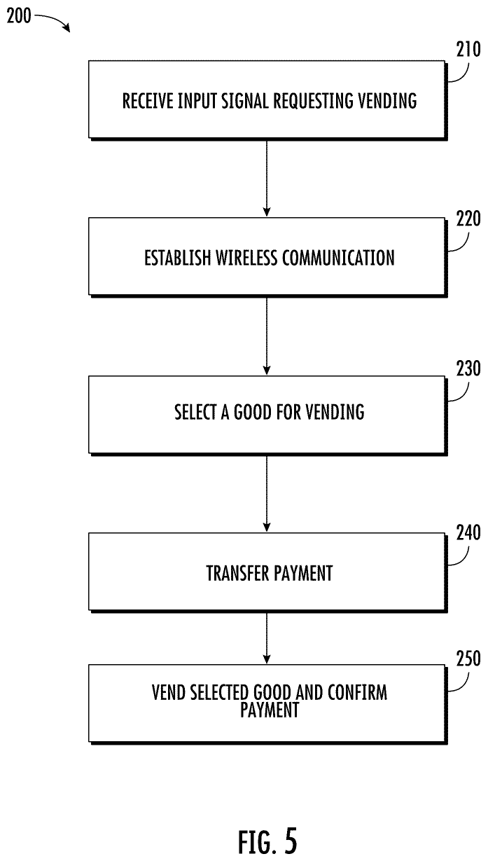

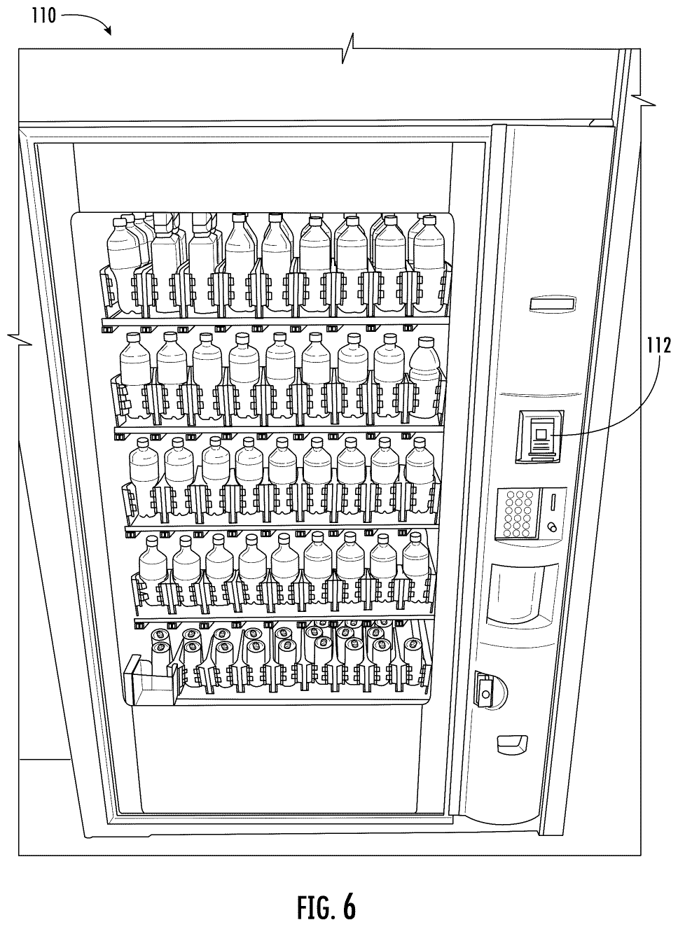

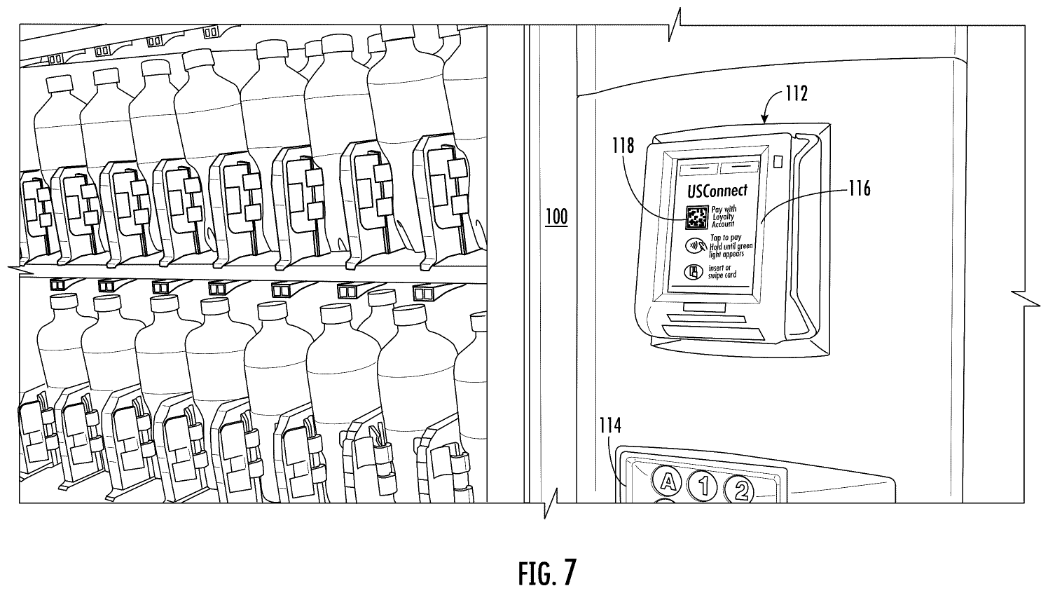

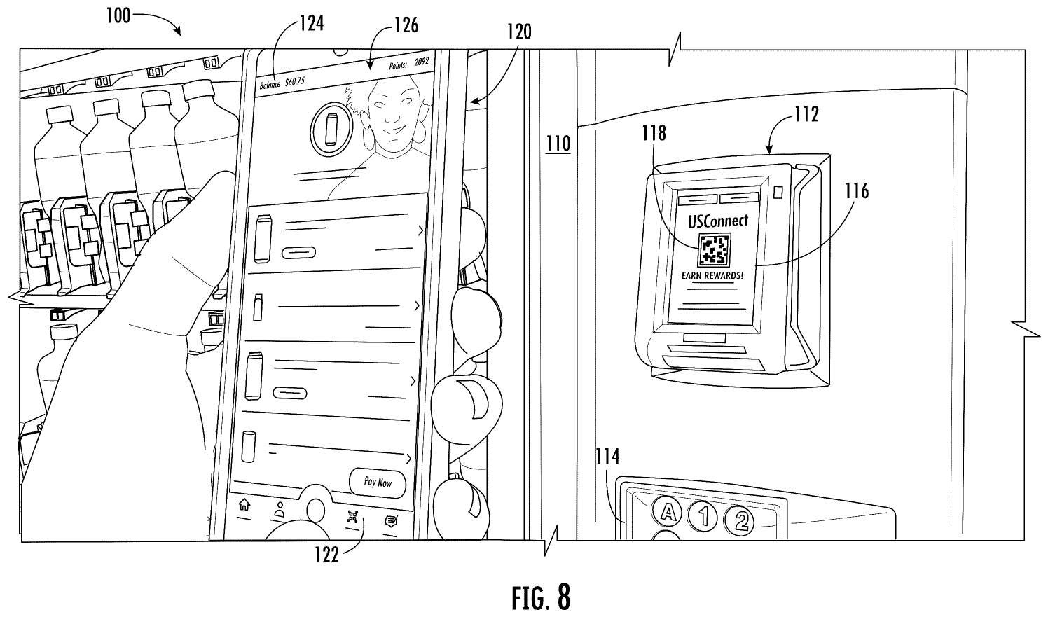

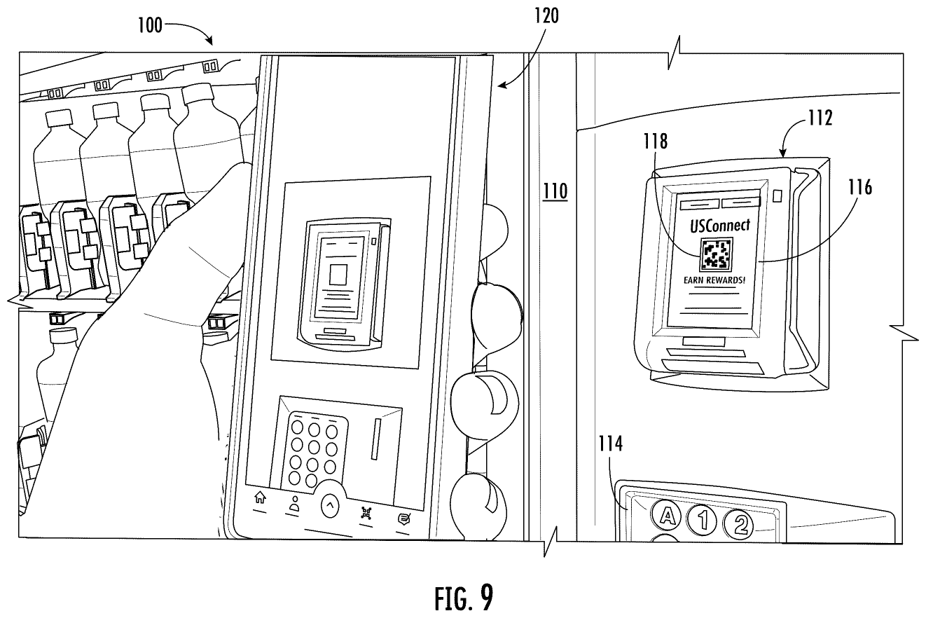

With reference to FIG. 5, a method 200 of cashless vending transactions in accordance with embodiments of the present disclosure is described with reference to an example vending machine system 100 of FIGS. 6-8. Throughout the description of the method 200 additional reference is made to FIGS. 9-13 which illustrate the several processes of the method 200.

With reference to FIGS. 6-8, the vending machine 110 includes the telemeter or cashless payment device 112 and a number pad 114. The number pad 114 may be used to select a specific good for vending from the vending machine 110. The cashless payment device 112 processes payments from a user and signals to a controller 1400 of the vending machine 110 to dispense a particular good. The cashless payment device 112 has a display screen 116 to display information during vending transaction. In some embodiments, the display screen 116 is a touch screen. The cashless payment device 112 may include a processor and memory. On the display screen 116 the cashless payment device 112 may display the quick-response code (QR code) 118. The QR code 118 is a machine-readable optical image consisting of a two-dimensional matrix. The QR code 118 may be read by the remote device 120 to facilitate vending transactions and the purchase of goods from the vending machine 110. The cashless payment device 112 may be a LYNK® device by GlobalConnect®. Additionally or alternatively, the cashless payment device 112 may receive payment from a debit or a credit card through conventional “swipe to pay”, “tap to pay”, or “insert to pay” methods.

The remote device 120 may be a cell phone, tablet, computer, or other portable device capable of wireless communication with the cashless payment device 112. The remote device 120 includes a camera to read the QR code 118. The remote device 120 may include the vendor application 126 installed thereon that displays a user interface on a screen of the remote device 120 and provides instructions and options for performing vending transactions. The vendor application 126 may be part of a vendor loyalty program and may be connected to or associated with a user specific loyalty account. The loyalty account may have an account balance 124 from which payment is disbursed during a vending transaction. In embodiments, the loyalty account may be connected to a debit or credit card and payment for vending transaction charged directly to or disbursed directly from the debit or credit card.

The method 200 is executed by the vending machine system 100 through the cashless payment device 112 and the remote device 120 communicating through the telemeter server 910 and the remote server 920. The cashless payment device 112 detects an input signal requesting initiation of a vending transaction from the remote device 120 (Process 210). The input signal may be sent from the remote device 120 to the cashless payment device 112 by scanning the QR code 118 displayed on the display screen 116. The QR code 118 may be scanned within a vendor application 126 installed on the remote device 120. The vendor application 126 may have a button 122 for initiating a scan QR code function, as shown in FIG. 2. Pressing the button 122 opens a scanning interface (FIG. 9) that utilizes a camera of the remote device 120 to read the QR code 118 displayed on the display screen 116. In embodiments, the QR code 118 may be scanned with a remote device 120 without the vendor application 126 installed thereon. In such embodiments, upon scanning the QR code 118, the remote device 120 may be redirected to the application store, e.g., The App Store® or the Google Play Store®, to download and install the vendor application 126.

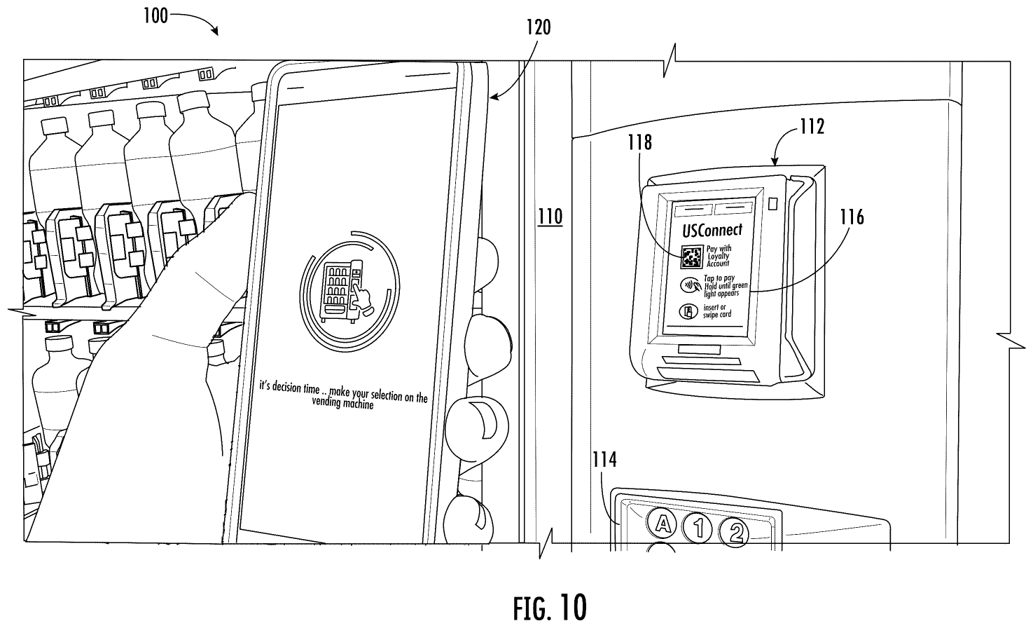

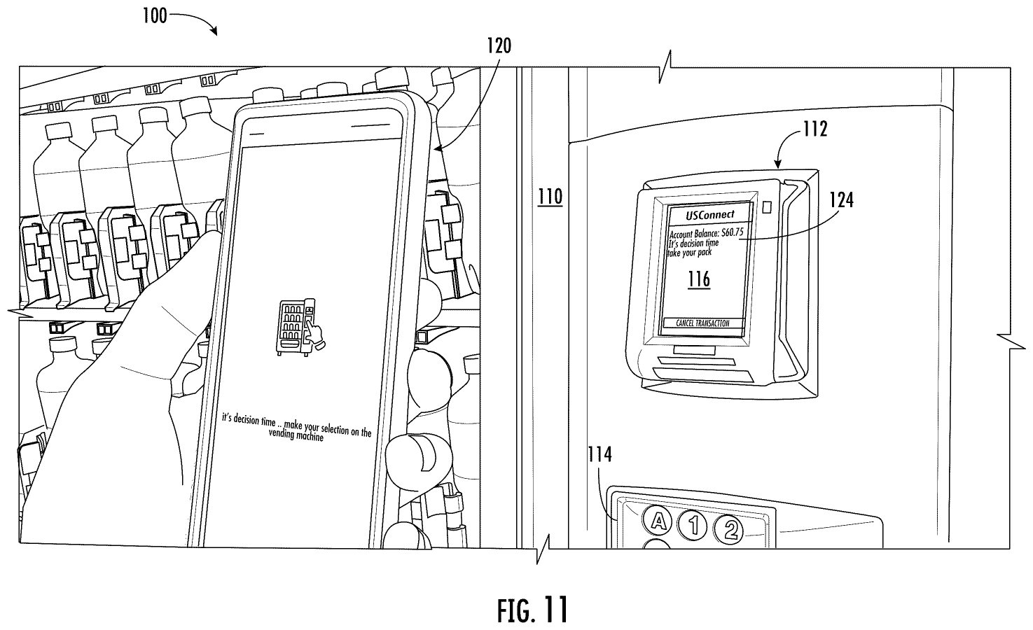

As shown in FIG. 10, once the input signal is received by the cashless payment device 112, the vending transaction is initiated and the remote device 120 and the cashless payment device 112 establish wireless communication with one another (Process 220). With wireless communication established, an account balance 124 for a loyalty account may be displayed on the display screen 116 of the cashless payment device 112 or the remote device 120 and instructions to select a good for vending from the vending machine 110 are displayed on the remote device 120 and/or the cashless payment device 112 (FIG. 11). Establishing wireless communication between the cashless payment device 112 and the remote device 120 may include authenticating a user.

The number pad 114 may be used to select a desired good in the vending machine 110 for purchase and vending (Process 230). In some embodiments, selecting the good for purchase may be performed on the remote device 120, without contacting the number pad 114, for a touchless vending transaction. For example, in embodiments, a digital number pad corresponding to the number pad 114 on the vending machine 110 may be displayed on the remote device 120 and the desired good selected by inputting, e.g., by typing on the remote device 120, the number corresponding to the desired good. In certain embodiments, images of goods contained within the vending machine 110 are displayed on the remote device 120 and selected for purchase by interfacing with the remote device 120, e.g., touching a screen of the remote device 120. Once a user has selected a good for purchase, the purchase price of the selected good is transacted across the wireless communication between the remote device 120 and the cashless payment device 112 (Process 240).

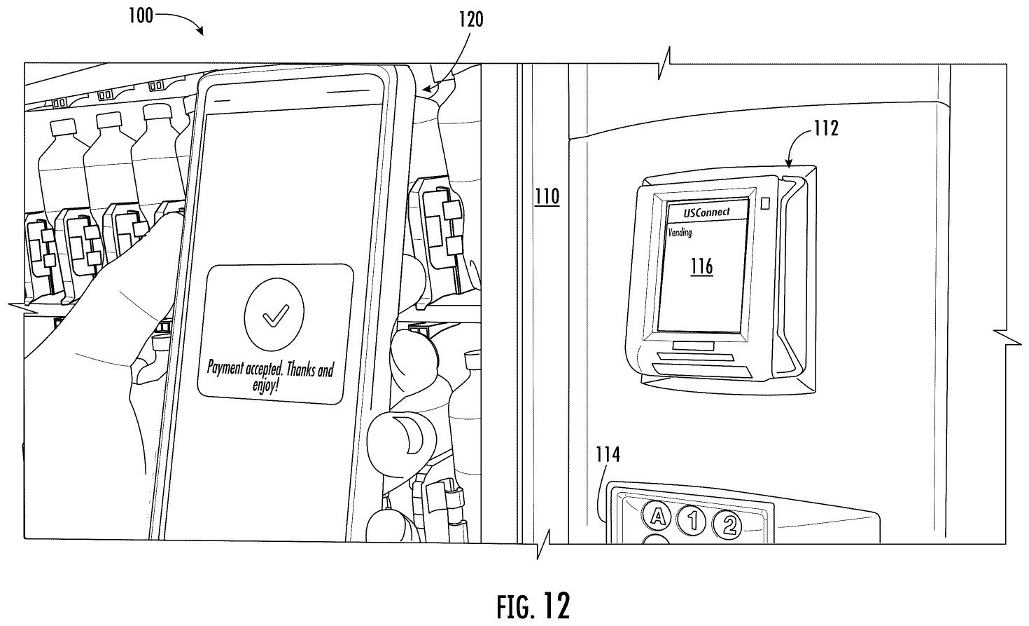

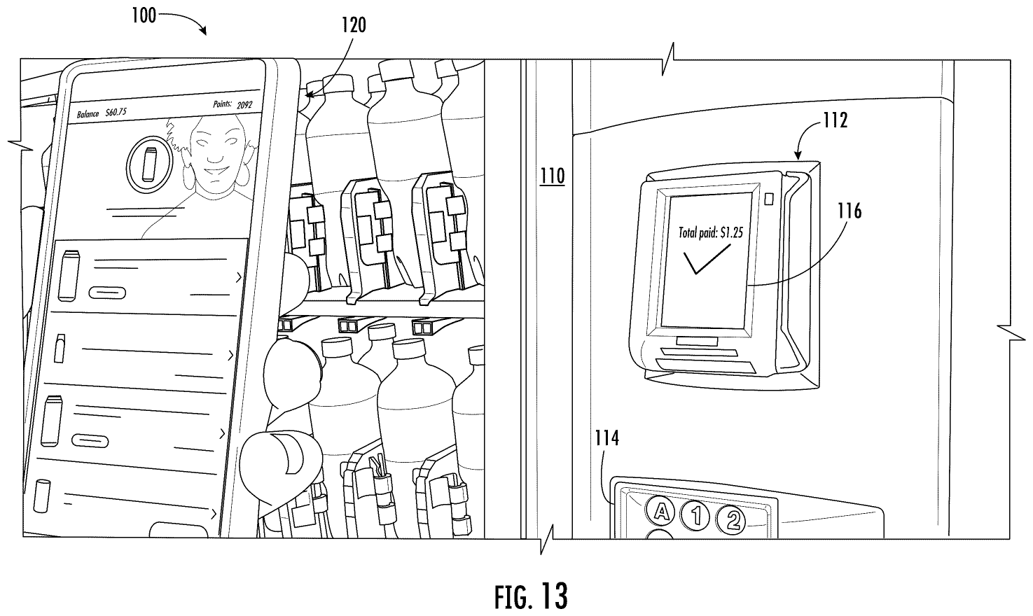

As shown in FIGS. 12 and 13, payment is confirmed on the remote device 120, the display screen 116 of the cashless payment device 112, or both the remote device 120 and the cashless payment device 112 (Process 250). With payment of the purchase price, a controller 1400 of the vending machine 110 issues a command signal to vend the selected good. The remaining account balance 124 on the loyalty account after the vending transaction may be displayed on either the remote device 120 or the cashless payment device 112. The selected good is dispensed and may be retrieved by the user. In some embodiments, the vending machine 110 may be configured to accept return of goods and disbursement of refunds.

In certain embodiments, scanning the QR code 118 may allow for a guest checkout functionality, without the use of a vendor application 126 installed on the remote device 120. A camera of the remote device 120 may scan the QR code 118 displayed on the display screen 116 and establish a connection between the remote device 120 and the cashless payment device 112 for payment utilizing an electronic wallet. For example, scanning the QR code 118 may allow for payment via Apple Pay®, Samsung Pay®, Google Pay®, Cash App®, Venmo®, or other such payment processors.

In some embodiments, because this is machine and account specific, when the QR code 118 is scanned, a promotion can be added to the machine which allows for a specific good to be vended at no charge, a reduced price, a two for one deal (e.g., buy one, get one free), etc. For example, a promotion could just say X bag of chips is available for free. Or if you buy X, you will get this for free or for this price vs. the normal price. Various further promotions are readily understood and arranged in keeping with the teachings herein. Because this is account and machine specific, promotions as described above can be done in real time. With reference to the drawings, for implementation in various embodiments, the decision to offer a promotion, communication of the promotion to the vending machine 110, and/or to remote device 120, the display of aspects of the promotion, acceptance of the promotion by a user, and vending of the specific good according to the promotion may be implemented in processes on the remote device 120, the remote server/loyalty server 920, the telemeter server/link server 910 and the vending machine 110, as shown at least in FIGS. 1, 6 and 7.

FIG. 14 is a block diagram of an example controller 1400 that may perform one or more of the operations described herein, in accordance with some embodiments. As shown in FIG. 14, the controller 1400 performs the processes of the cashless payment device 112. The vending machine system 100 may include a plurality of controllers 1400 to perform the process of the various aspects of the vending machine system 100. The controller 1400 may be in signal communication with other computing devices or controllers by being integrated therewithin or connected via a WAN or a LAN, an intranet, an extranet, and/or the Internet. In some embodiments, while only a single controller 1400 is illustrated, the term “controller” may be taken to include any collection of controllers that individually or jointly execute a set (or multiple sets) of instructions to perform the methods discussed herein.

The example controller 1400 may include a processing device (e.g., a general purpose processor, a PLD, etc.) 1402, a main memory 1404 (e.g., synchronous dynamic random access memory (DRAM), read-only memory (ROM)), a static memory 1406 (e.g., flash memory), and a data storage device 1418, which may communicate with each other via a bus 1430.

Processing device 1402 may be provided by one or more general-purpose processing devices such as a microprocessor, central processing unit, or the like. In an illustrative example, processing device 1402 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1402 may comprise one or more special-purpose processing devices such as an application specific integrated circuit (ASIC), a field programmable gate array (FPGA), a digital signal processor (DSP), network processor, or the like. The processing device 1402 may be configured to execute the operations described herein, in accordance with one or more aspects of the present disclosure, for performing the operations and steps discussed herein.

The data storage device 1418 may include a machine-readably or computer-readable storage medium 1428 on which may be stored one or more sets of instructions 1425 that may include instructions for one or more components for carrying out the operations described herein, in accordance with one or more aspects of the present disclosure. Instructions 1425 may reside, completely or at least partially, within main memory 1404 and/or within processing device 1402 during execution thereof by controller 1400, main memory 1404, and processing device 1402 constituting computer-readable media. The instructions 1425 may be transmitted or received over a communication interface 1420 via interface device 1408.

While computer-readable storage medium 1428 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” may be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Examples described herein may relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

Although the method operations or steps are described in a specific order, it should be understood that other operations and steps may be performed in between described operations and steps, described operations and steps may be adjusted so that they occur at slightly different times, or the described operations and steps may occur in any order unless otherwise specified.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed is:

1. A method for cashless vending of goods of a vending machine, performed by one or more servers, the method comprising:
receiving, at the one or more servers, a code sent from a remote device in wireless communication with the one or more servers, the code indicative of a specific vending machine;
transmitting, from the one or more servers, an available balance to the specific vending machine;
receiving, at the one or more servers, a transaction amount from the specific vending machine based on a selected good; and
deducting the transaction amount from the available balance.

2. The method for cashless vending of goods of a vending machine, performed by one or more servers, of claim 1, further comprising:
adding a promotion for a specific good to be vended at no charge or reduced price, to the specific vending machine in response to receiving the code from the remote device.

3. The method for cashless vending of goods of a vending machine, performed by one or more servers, of claim 1, wherein:
the code that indicates the specific vending machine is a quick-response (QR) code displayed by the specific vending machine.

4. The method for cashless vending of goods of a vending machine, performed by one or more servers, of claim 1, wherein:
the code that indicates the specific vending machine is a quick-response (QR) code that is read by the remote device.

5. The method for cashless vending of goods of a vending machine, performed by one or more servers, of claim 1, further comprising:
generating, by the one or more servers, a quick-response (QR) code; and
communicating the QR code from the one or more servers to the specific vending machine, to be displayed by the specific vending machine as the code that indicates the specific vending machine.

6. The method for cashless vending of goods of a vending machine, performed by one or more servers, of claim 1, further comprising:
receiving, by the one or more servers, a purchase and vending selection indicating the selected good, from the specific vending machine.

7. The method for cashless vending of goods of a vending machine, performed by one or more servers, of claim 1, wherein:
receiving, by the one or more servers, a purchase and vending selection indicating the selected good, from the remote device.

8. A vending machine system for cashless vending of goods, comprising:
one or more servers, configured for communication with one or more vending machines and communication with one or more remote devices; and
the one or more servers to perform a method comprising:
receiving, at the one or more servers, a code sent from a remote device in wireless communication with the one or more servers, the code indicative of a specific vending machine;
transmitting, from the one or more servers, an available balance to the specific vending machine;
receiving, at the one or more servers, a transaction amount from the specific vending machine based on a selected good; and
deducting the transaction amount from the available balance.

9. The vending machine system for cashless vending of goods of claim 8, wherein the method to be performed by the one or more servers further comprises:
adding a promotion for a specific good to be vended at no charge or reduced price, to the specific vending machine in response to receiving the code from the remote device.

10. The vending machine system for cashless vending of goods of claim 8, further comprising:
the one or more vending machines, each arranged to display a quick-response (QR) code to indicate the specific vending machine.

11. The vending machine system for cashless vending of goods of claim 8, wherein the method to be performed by the one or more servers further comprises:
generating, by the one or more servers, a quick-response (QR) code; and
communicating the QR code from the one or more servers to the specific vending machine, to be displayed by the specific vending machine as the code that indicates the specific vending machine.

12. The vending machine system for cashless vending of goods of claim 8, wherein the method to be performed by the one or more servers further comprises:
receiving, by the one or more servers, a purchase and vending selection indicating the selected good, from the specific vending machine.

13. The vending machine system for cashless vending of goods of claim 8, wherein the method to be performed by the one or more servers further comprises:
receiving, by the one or more servers, a purchase and vending selection indicating the selected good, from the remote device.

14. A server-based vending machine system for cashless vending of goods, comprising:
two servers, including a remote server, to communicate with vending machines and remote devices, wherein such remote devices are to communicate with such vending machines through the two servers; and
the two servers, to perform a method comprising:
receiving, at the remote server, a code sent from a remote device in wireless communication with the remote server, the code indicative of a specific vending machine;
transmitting, from the remote server, an available balance to the specific vending machine;
receiving a transaction amount from the specific vending machine based on a selected good; and
deducting the transaction amount from the available balance.

15. The server-based vending machine system for cashless vending of goods of claim 14, wherein the method further comprises:
adding a promotion for a specific good to be vended at no charge or reduced price, to the specific vending machine in response to receiving the code from the remote device.

16. The server-based vending machine system for cashless vending of goods of claim 14, wherein:
the code that indicates the specific vending machine is a quick-response (QR) code displayed by the specific vending machine.

17. The server-based vending machine system for cashless vending of goods of claim 14, wherein:
the code that indicates the specific vending machine is a quick-response (QR) code that is read by the remote device.

18. The server-based vending machine system for cashless vending of goods of claim 14, wherein the method further comprises:
generating a quick-response (QR) code; and
communicating the QR code to the specific vending machine, to be displayed by the specific vending machine as the code that indicates the specific vending machine.

19. The server-based vending machine system for cashless vending of goods of claim 14, wherein the method further comprises:
receiving a purchase and vending selection indicating the selected good, from the specific vending machine.

20. The server-based vending machine system for cashless vending of goods of claim 14, wherein the method further comprises:
receiving a purchase and vending selection indicating the selected good, from the remote device.
